(19) United States
(12) Patent Application Publication
(10) Pub. No.: US 2026/0103412 A1
(43) Pub. Date: Apr. 16, 2026

(54) MODULAR FLOWRATE SENSOR ASSEMBLY FOR CHLORINATOR

(71) Applicants: Kevin Doyle, Pompano Beach, FL (US); Rakesh Reddy, Boca Raton, FL (US)

(72) Inventors: Kevin Doyle, Pompano Beach, FL (US); Rakesh Reddy, Boca Raton, FL (US)

(21) Appl. No.: 19/194,643

(22) Filed: Apr. 30, 2025

Related U.S. Application Data
(63) Continuation-in-part of application No. 18/913,149, filed on Oct. 11, 2024, now Pat. No. 12,312,260.

(51) Int. Cl. C02F 1/467; C02F 1/461; C02F 103/42; G01F 1/115; G01F 15/14

(52) U.S. Cl. CPC C02F 1/4674; C02F 1/46109; G01F 1/115; G01F 15/14; C02F 2001/46152; C02F 2103/42; C02F 2201/46145; C02F 2209/40

(57) ABSTRACT

A modular flow sensor assembly can include a cage having at least one bearing, a shaft coupled to the bearing(s) and oriented in a direction substantially parallel to a direction of flow through the sensor assembly, and multiple turbine blades coupled to the shaft. The module flow sensor assembly can be configured such that it does not include any electrical connections, allowing the assembly to provide information to external sensors without itself requiring power. At least one of the turbine blades can include a magnet, allowing an external sensor to detect the rotational speed of the turbine blades and allowing for calculation of the current flow rate. The cage of the flowrate sensor assembly can be shaped such that it can be easily inserted or removed from a chlorinator device.

### BACKGROUND

Swimming pools and other bodies of water generally require proper water circulation and treatment to maintain water quality and safety. For example, circulation enables filtration, chemical treatment, heating, and cleaning of the water. Chlorination is a common method used to disinfect pool water and prevent the growth of harmful microorganisms.

Conventional chlorination systems for pools typically utilize chlorine tablets or liquid chlorine that must be manually added to the water on a regular basis. This manual approach can be inconvenient for pool owners and may lead to inconsistent chlorine levels if not performed diligently. Additionally, storing and handling chlorine chemicals can pose safety risks.

Some automated chlorination systems have been developed to address the drawbacks of manual chlorination. These systems often use salt chlorination, where salt is added to the pool water and electrolysis is used to generate chlorine. However, existing automated systems frequently have limitations. For example, many systems lack the ability to accurately measure and control chlorine production based on real-time pool conditions and usage.

Another challenge with conventional chlorination systems is the reliance on complex onboard electronics for control and monitoring functions. These onboard electronics can be expensive to repair or replace if they malfunction, oftentimes requiring replacement of the entire chlorinator device that houses the onboard electronics. The electronics may also be susceptible to damage from exposure to water and pool chemicals over time.

Additionally, most existing chlorination systems operate in isolation from other pool equipment and environmental factors. This can result in inefficient operation, as the chlorination system may not account for variables like weather conditions, swimmer load, or the performance of the filtration system when determining chlorine production levels.

Therefore, a problem exists with current pool chlorination systems with respect to their ability to efficiently and accurately maintain proper chlorine levels while minimizing maintenance requirements and costs. There is a need for improved chlorination systems that can overcome these limitations.

### SUMMARY

Examples described herein include systems and methods for generating chlorine in a body of water. In one example, a chlorinator device for generating chlorine in a body of water is disclosed. The chlorinator device includes a housing having an inlet end and an outlet end, where the inlet and outlet ends are in communication with the body of water. The chlorinator device can further include at least one flowrate sensor mounted within the housing and positioned to measure the flowrate of water through the housing. Additionally, the chlorinator device can include at least one electrolyte plate mounted within the housing and positioned to contact water flowing through the housing, and the one or more electrolyte plates can be electrified such that they convert salt within the water into chlorine.

In some examples, the flowrate sensor includes a turbine that rotates based on water flowing through the turbine which causes the rotation. The flowrate sensor may utilize at least one Hall-effect sensor configured to determine a rotational speed of the turbine. The flowrate sensor may be configured to generate information sufficient to derive a current flowrate through the chlorinator device.

In an example, the chlorinator device further includes an external controller coupled to the housing via an electrical cable and configured to communicate with the at least one flowrate sensor. The external controller can receive flowrate information generated by flowrate sensor. The external controller can use that information to inform various decisions regarding the pool and proper treatment of the water. It can also be configured to perform an encrypted handshake procedure with an onboard controller of the chlorinator device, to ensure compatibility between devices.

The chlorinator device can be configured to calculate pool turnover based on tracking flowrate through the chlorinator device for a period of time, calculating a volume of water based on flowrate information for the period of time, and comparing the calculated volume to a known volume of the body of water. Additionally, the chlorinator device may be configured to receive weather information and generate instructions based on the weather information. The chlorinator device may be further configured to transmit the generated instructions to at least one different device in communication with the body of water.

In some examples, the chlorinator device may be configured to connect to a wireless network and upload information to a cloud storage location. Based on flowrate information from the at least one flowrate sensor, the chlorinator device may be configured to detect a change in performance in a filtration system of the body of water. For example, the chlorinator device can be configured to detect that the filtration system is blocked. As another example, it can be configured to generate an alert based on detecting the change in performance in the filtration system.

An example method for generating chlorine in a body of water is also disclosed. The method may involve providing a chlorine generator comprising a housing having an inlet end and an outlet end in communication with the body of water, at least one flowrate sensor mounted within the housing and positioned to measure a flowrate of water through the housing, and at least one electrolyte plate mounted within the housing and positioned to contact water flowing through the housing, where the at least one electrolyte plate may be electrified such that it converts salt within the water into chlorine.

An example external controller for a chlorinator device is also disclosed herein. The external controller can be a controller for any example chlorinator device disclosed herein. The external controller can include a hardware-based processor configured to execute instructions stored on a non-transitory, computer-readable medium. The processor can be configured to receive flowrate information from the chlorinator device. The external controller can also include a power-supply connector for providing electrical communication between the external controller and a power source. It can also include a chlorinator connector for providing electrical communication between the external controller and the chlorinator device.

The example external controller can be physically separate from the chlorinator device, such as by including an independent housing from the housing of the chlorinator device. The external controller and chlorinator device can be coupled to one another by an electrical cable in an example.

The external controller can include a low-voltage data channel that receives the flowrate information from the chlorinator device. A low-voltage data channel can also be used to communicate between the external controller and a separate device, such as a pool controller. In an example, the pool controller queries the external controller with a request for information, and the external controller responds accordingly using the low-voltage data channel. The external controller can also include a wireless communication component that allows the processor to communicate wirelessly through a wireless network, such as a WIFI network.

The processor of the external controller can provide instructions to a pool component separate from the chlorinator or external controller. For example, it can generate an instruction to turn a pool pump on or off, to operate the pool pump at a certain speed, or to operate the pool pump for a certain period of time. It can also generate an instruction for other pool components, such as instructing activation of an acid pump or the opening of a fill or drain valve. The instructions generated by the processor can be based on various types of information, including weather information, pH information, oxidation-reduction potential (“ORP”) information, and pool usage information.

The processor of the external controller can also communicate with a mobile application on a user's device. In some examples, this communication is performed directly between the external controller and the user's device, such as by using a BLUETOOTH connection. In other examples, the external controller communicates with a server, or group of servers in a cloud architecture, which in turn communications with the mobile device executing on the user's device. This can allow the external controller to receive instructions from a user, receiving information from a user such as expected pool usage, and provide notifications or alerts to the user.

The external controller can include a step-down transformer that is capable of receiving high-voltage electricity from a power source, such as a 110 V power source, and convert it to lower-voltage electricity that is usable by components of the external controller and chlorinator device, such as 40 V power.

The external controller can also be configured to track usage time associated with the chlorinator device, which can provide information relevant to warranty claims for the manufacturer. The external controller can also use encryption for communications between the external controller and chlorinator device. In some examples, this includes an encrypted handshake procedure to verify that the external controller and chlorinator device are both genuine articles from the manufacturer.

Ax example method for externally controlling a chlorinator device such as the example chlorinator device described herein. The example method can include providing an external controller that includes a hardware-based processor, a power-supply connector for providing electrical communication between the external controller and a power source, and a chlorinator connector for providing electrical communication between the external controller and the chlorinator device. The example method can include receiving flowrate information from the chlorinator device, such as from a flow sensor within the chlorinator device. The method can also include generating an instruction at the external controller based, at least in part, on the flowrate information.

The example method can also include providing the generated instruction to a pool controller. In another example, the method includes providing the generated instruction to a server using a wireless network. In some examples, the generated instruction instructs a pool component to activate, such as turning on a heat pump. The instruction can also be based on at least one of weather information, pH information, ORP information, temperature information, or pool usage information, or some combination thereof. The instruction can also be based on information or instructions obtained from a user.

In another example, a chlorinator device is provided for generating chlorine in a body of water. The device can include a housing having an inlet and an outlet, and at least one electrolyte plate mounted within the housing and positioned to contact water flowing through the housing to convert salt within the water into chlorine. The chlorinator device can also include a flowrate sensor assembly. The assembly can include a cage having at least one bearing, and at least one turbine blade inside the cage and coupled to the at least one bearing, either directly or by way of a shaft. The flowrate sensor assembly can be configured such that it does not include any electrical connections, allowing for modular installation and removal from the chlorinator device.

An example method is also included for installing a flowrate sensor assembly in a chlorinator device having an inlet and an outlet. The method can include providing the flowrate sensor assembly, which includes a cage having at least one bearing, at least one turbine blade inside the cage and coupled to the at least one bearing, directly or indirectly, and a lip that protrudes from the cage. The method can also include inserting the flowrate sensor assembling into the inlet of the chlorinator device such that the lip contacts an outer surface of the inlet. The method can further include securing the flowrate sensor assembly to the inlet by installing a threaded connector that presses the lip against the outer surface of the inlet.

Both the foregoing general description and the following detailed description are exemplary and explanatory only and are not restrictive of the examples, as claimed.

### BRIEF DESCRIPTION OF THE DRAWINGS

FIG. 1 is a system architecture diagram of an example chlorinator system.

FIG. 2 is a perspective view of an example chlorinator device with external controller according to one or more embodiments herein.

FIG. 3 is a perspective, cross-sectional view of the example chlorinator device of FIG. 2.

FIG. 4 is a perspective, cross-sectional view of the example chlorinator device of FIG. 2.

FIG. 5 is a perspective, cross-sectional view of the example chlorinator device of FIG. 2.

FIG. 6 is a flowchart of an example method in accordance with one or more embodiments herein.

FIG. 7 is a flowchart of an example method in accordance with one or more embodiments herein.

FIG. 8 is a flowchart of an example method in accordance with one or more embodiments herein.

FIG. 9 is a flowchart of an example method in accordance with one or more embodiments herein.

FIG. 10 is a flowchart of an example method in accordance with one or more embodiments herein.

FIG. 11 is a cross-sectional view of an example external controller according to one or more embodiments herein.

FIG. 12 is a perspective view of an example flowrate sensor according to one or more embodiments herein.

FIG. 13 is a perspective, exploded view of the example flowrate sensor of FIG. 12.

### DETAILED DESCRIPTION

Reference will now be made in detail to the present examples, including examples illustrated in the accompanying drawings.

Disclosed herein are devices, systems, and methods directed to flow-based chlorination mechanisms and techniques. In one example, a chlorinator device is provided for generating chlorine in a body of water. The chlorinator includes a housing with an inlet and outlet end, a flowrate sensor mounted within the housing to measure water flowrate, and electrolyte plates mounted within the housing to contact flowing water and convert salt into chlorine. The device can include an external controller for processing flowrate information, obtaining information from a cloud platform or other external sources, and controlling chlorine production. Methods for operating the chlorinator device, including adjusting chlorine production based on flowrate and external factors, are also disclosed.

The term “pool” is used for convenience throughout this disclosure to refer to any body of water, including pools, spas, hot tubs, reservoirs, ponds, or any other body of water. Similarly, the term “water” is used to describe the liquid mixture that fills the body of water and is not intended to imply pure water. Along the same lines, the term “chlorine” refers to hypochlorous acid, sodium hypochlorite, or any other disinfectant. These terms are not intended to be limiting in any way.

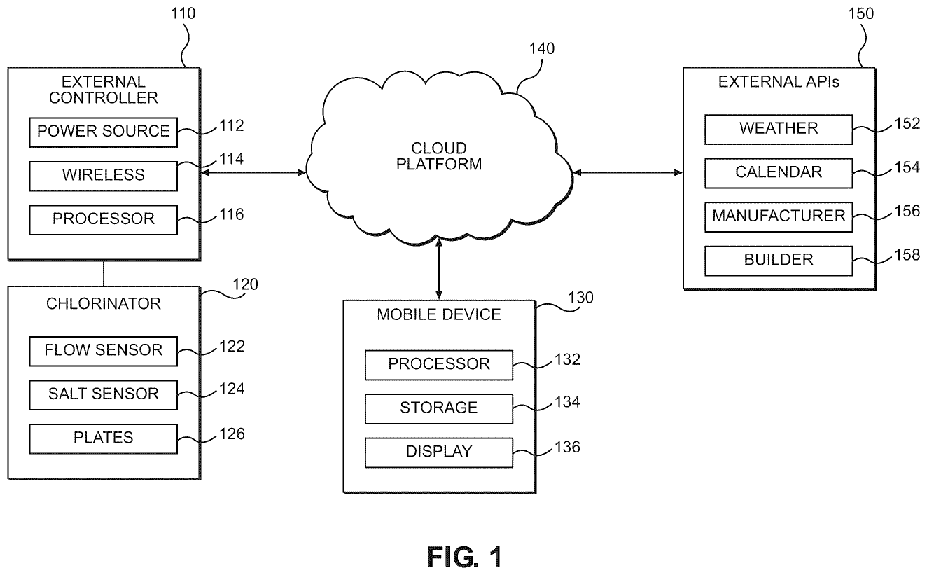

FIG. 1 provides a system architecture diagram that includes a chlorinator device 120 with an external controller 110, which communicates with a cloud platform 140. The cloud platform 140 can also communicate with a mobile device 130, such as through a mobile application on the mobile device 130. It can also communicate with external Application Programming Interfaces (“APIs”) that can provide various types of information. The cloud platform 140 can coordinate these various devices and sources of information to ensure optimal chlorination for a pool or other body of water.

The chlorinator device 120 of FIG. 1 includes a flow sensor 122, a salt sensor 124, and one or more electrolyte plates 126. The flow sensor 122 may be implemented in various ways to measure water flow through the chlorinator. For example, the flow sensor 122 can utilize a turbine, paddle wheel, ultrasonic sensor, or differential pressure sensor. In one implementation, the flow sensor 122 includes a turbine with blades that rotate as water flows through the sensor. The rotation speed of the turbine may be measured to determine the flow rate. For example, a Hall-effect sensor can measure the rotational speed to estimate rotations per minute. In another example, the flow sensor 122 can use ultrasonic transducers to measure the transit time of ultrasonic pulses through the water flow to calculate flow rate. In yet another example, the flow sensor 122 merely determines whether the circulation system of the pool is stagnant or flowing.

The flow sensor 122 can be positioned within the body of the chlorinator 120 such that all water passing through the chlorinator 120 also passes through the flow sensor 122 and is therefore measured. Additionally, the chlorinator 120 can be plumbed into the circulation system of the relevant pool such that all water circulating through the system passes through the chlorinator, and therefore the flow sensor 122. In this way, the flow sensor 122 can provide an accurate measurement of the circulation rate of the overall pool circulation system.

The chlorinator device 120 can also include a salt sensor 124 that measures the salinity or conductivity of the water passing through the chlorinator 120. Various types of salt sensors may be employed, such as inductive, conductive, or optical sensors. For instance, the salt sensor 124 may use a pair of electrodes to measure the electrical conductivity of the water, which correlates to salinity. Alternatively, the salt sensor 124 can use an optical refractometer to determine salinity based on the refractive index of the water. Measurements provided by the salt sensor 124 can be used to determine an optimal power level to be applied to the electrolyte plates 126, which interact with the salt to produce chlorine. A low salt concentration can lead to insufficient chlorine generation, for example, and require additional power to be applied to the electrolyte plates 126.

The electrolyte plates 126 can be implemented as a single plate, in one example, or as a series of parallel metal plates, for example titanium with a ruthenium oxide coating. The plates 126 can be arranged in various configurations within the chlorinator housing to maximize water contact. For example, the plates may be oriented vertically, horizontally, or at an angle. The spacing between plates and total surface area may be optimized for chlorine generation efficiency. In some implementations, the plates 126 may have a mesh or perforated design to increase surface area.

The system of FIG. 1 can also include an external controller 110 that can communicate with the chlorinator device 120 and provide various instructions as well as power for running the components within the chlorinator device 120. In some embodiments, the external controller 110 is a separate physical device from the chlorinator 120, connected by an electrical cable.

The external controller 110 can include a power source 112, wireless communication capabilities 114, and a hardware-based processor 116. It can also include memory storage. The external controller 110 can further include external indicators such as lights, a display, or a combination thereof. It can also include audio capabilities. Furthermore, the external controller 110 can include input mechanisms, such as a button or touchscreen, that allows a maintenance person to interact with the controller 110.

In some examples, the processor 116 of the external controller 110 is configured to perform an encrypted handshake with an onboard processor of the chlorinator 120. This can include, for example, a request-response sequence between the devices that confirms that the chlorinator 120 has stored a key indicating that it is a genuine device from the manufacturer. This can prevent the external controller 110 from being used with a chlorinator that is not designed to work with the external controller 110, such as a counterfeit device. Similarly, the respective processors of these devices 110, 120 can be configured to communicate using encrypted digital communication techniques, protecting the data transmission from unauthorized interceptions.

The power source 112 depicted in FIG. 1 can be a power-supply connector for providing electrical communication between the external controller 110 and a separate power source. For example, the separate power source can be a power supply control box that provides power to multiple components of a pool system, such as pumps and sensors. The power supply control box can include an outlet into which a power cable can be connected, electrically coupling the external controller 110 to the power supply control box.

The power source 112 components of the external controller 110 can also include a step-down transformer that receives power from a separate power supply, such as a power supply control box, and transforms it to a lower voltage for use with the chlorinator device 120. In one example, the power source 112 components transform 110V power received from the separate power supply into 40V power suitable for use by the chlorinator device 120.

The external controller 110 can wirelessly communicate with a cloud platform 140. The cloud platform 140 may serve as a central hub for data storage, processing, and communication between various components of the system. The cloud platform 140 can be implemented in a server, or a group of servers such as in a distributed datacenter software-defined data center. In an example, the cloud platform 140 can provide updates and instructions to the external controller 110.

The system of FIG. 1 may also include a mobile device 130, which can be any type of computing device such as a phone, tablet, or laptop or desktop computer. The mobile device 130 can include a hardware-based processor 132, memory storage 134, and a display 136. It can be used to remotely monitor and control the chlorinator system.

The cloud platform 140 can interface with external APIs 150, such as by making API calls through a computing system. The APIs can provide various types of information, including weather information 152, calendar data 154, manufacturer information 156, and builder information 158. This integration allows the system to incorporate external data into its decision-making processes.

The weather API 152 can provide real-time and forecasted weather information that may be used to adjust chlorine production based on environmental factors. For example, higher temperatures or expected rainfall can trigger increased chlorine production. This determination can be made the cloud platform 140 in some examples. In other scenarios, the determination of how to incorporate weather information, or any other information pulled via API calls, can be performed by a mobile application executing on the mobile device 130.

The calendar API 154 can provide information about scheduled pool usage or maintenance, which may be used to optimize chlorine production and system operation. As an example, the calendar API 154 can connect to a user's calendar information, which is typically stored online in a capacity amenable to sharing with external endpoints. As an example, a user's calendar to be synced to the cloud platform 140 through the calendar API 154, and the cloud platform 140 can perform the necessary processing to determine when to expect heavier or lighter pool usage.

To provide a more specific example, a user can input into the mobile device 130 a calendar event indicating that they are having a party at their house. This information can be pulled by the cloud platform 140 using the appropriate API. If the weather is expected to be within an acceptable range during the party, the cloud platform 140 can determine that a higher than average number of people are likely to use the pool on the day of the party. For a period of time before the party, such as 12 or 24 hours, the cloud platform 140 can instruct the chlorinator 120 to boost chlorine production for that time period.

The manufacturer API 156 can provide access to manufacturer-specific information, updates, or support services. This can include firmware updates, troubleshooting guides, or performance optimization recommendations.

The builder API 158 can provide information relevant to the pool's construction, such as volume, surface area, or specific equipment details. This information can be used to fine-tune the chlorinator's operation for the specific pool configuration.

Although these sources of information are described as APIs, they can be any electronic transmission mechanism. Any type of request made by a server, and any type of response from the source of information back to the server, can be used in place of the API mechanisms described herein, to similar effect and result.

In some examples, the cloud platform 140 analyzes the data received from these various sources 150 to provide intelligent, adaptive control of the chlorinator system. For example, it may adjust chlorine production based on anticipated weather conditions, scheduled pool usage, and historical performance data.

In some embodiments, the mobile application executing on the mobile device 130 provides a user interface for monitoring and controlling the chlorinator 120 and other pool-related systems. The application can display various types of information and visual cues to the user via the display 136. The storage 134 in the mobile device 130 can store historical data about the system's performance, user preferences, and configuration settings. This data can be synchronized with the cloud platform 140 to ensure consistency across different access points and to provide backup. The application may display current system status, historical data, and allow the user to adjust settings or respond to alerts.

For example, the mobile application can generate and display warnings about filtration blockages detected by the chlorinator 120. These warnings may be based on flow rate data from the flow sensor 122, which can indicate reduced water flow through the chlorinator 120 compared to historical or expected values. The expected values can be determined by taking into account the current and historical speed of the pool pump in some examples.

The mobile application may also alert users to potential issues with pool pump performance. For instance, if the flow sensor 122 consistently detects lower-than-expected flow rates, the application can generate a warning suggesting that the pool pump may be weakening or requiring maintenance.

Additionally, the mobile application can display any other problems or anomalies identified by the chlorinator 120. These include issues related to salt levels (as detected by the salt sensor 124), water chemistry imbalances, or power supply irregularities, as examples.

The mobile application may also provide scheduling features that allow users to input information about planned pool usage. For instance, a user may indicate through the application that a large number of people will be using the pool on an upcoming weekend. Based on this information, the system may adjust the chlorinator 120 settings to increase chlorine production in preparation for the higher demand.

Conversely, if a user indicates through the application of the mobile device 130 that the pool will not be used for an extended period, the system may reduce chlorine production to conserve resources. These adjustments may be made by modifying the power level applied to the electrolyte plates 126 in the chlorinator 120.

In some embodiments, the mobile application can include a feature for monitoring and displaying pool water turnover rates. Pool turnover be calculated based on flow rate data from the flow sensor 122 and known pool volume information, such as information obtained via the builder API 158. The application can alert users if the turnover rate falls below recommended levels, which could indicate issues with the filtration system or pump. In one example, the recommended level is that a pool be fully turned over (i.e., the entire volume of the pool pumped through the filtration system) within 24 hours.

The mobile application may also provide a user interface for manually adjusting chlorinator settings, initiating cleaning cycles, or overriding automatic functions when desired. These controls can be particularly useful for pool maintenance professionals or experienced pool owners who wish to fine-tune the system's operation.

In some implementations, the mobile application includes a feature for tracking and displaying historical data related to pool chemistry, chlorine production, and system performance. This data can be stored in the storage 134 of the mobile device 130 or in the cloud platform 140, allowing users to review trends over time and make informed decisions about pool maintenance.

The mobile application can also integrate with the calendar API 154 to allow users to set recurring maintenance tasks or schedule pool service appointments. These calendar events can be set to trigger reminders or automatic system adjustments as appropriate.

In some embodiments, the mobile application may include a troubleshooting guide or virtual assistant feature. This feature can use data from the chlorinator 120 and other connected systems to diagnose potential issues and provide step-by-step guidance for resolving common problems.

The mobile application may also facilitate communication with pool service professionals. For example, it may include a feature for sending system data and diagnostic information directly to a service company, streamlining the process of diagnosing and resolving issues.

In some examples, the mobile application includes a feature for optimizing energy usage. This feature can analyze data from the chlorinator 120, pump performance, historical and scheduled pool usage information, and external factors like electricity rates and weather forecasts to suggest the most energy-efficient operating schedule for the pool system.

In some examples, the mobile application provides a feature for controlling other pool equipment, such as pumps, heaters, and lighting systems, all from a single interface. This integration can allow for more efficient pool management and energy use.

In some embodiments, the mobile application includes a troubleshooting guide to help users diagnose and resolve common pool problems. This guide can use data from the chlorinator 120 and other connected devices to provide targeted advice. The mobile application may also provide educational content about pool chemistry and maintenance, helping users to better understand and care for their pools.

In some examples, the mobile application includes a social sharing feature, allowing users to compare their pool's performance with friends or neighbors who also use the system. This feature can be used to gamify pool maintenance and encourage best practices and further investment into pool equipment and services.

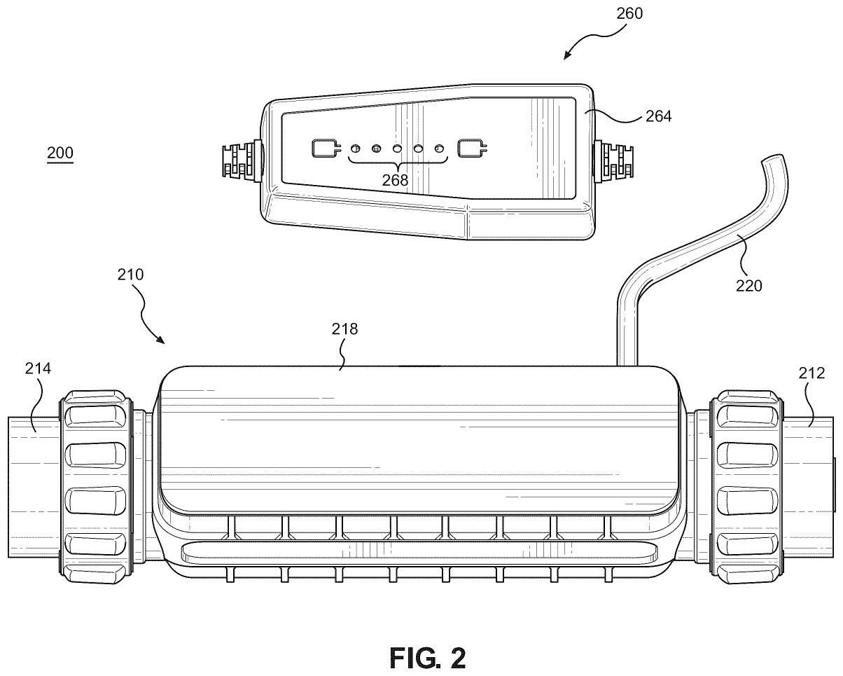

FIG. 2 illustrates an example chlorinator system 200, including a chlorinator device 210 that can be used in the system shown in FIG. 1. For example, the chlorinator device 210 can correspond to the chlorinator 120 depicted in and described with respect to FIG. 1. The chlorinator device 210 includes a housing 218 with an inlet end 212 and an outlet end 214. The inlet end 212 and outlet end 214 can include end caps or fittings for connecting the chlorinator device 210 to plumbing of a pool circulation system.

An electrical cable 220 extends from the housing 218 and can be used to connect the chlorinator device 210 to an external controller 260, which can be the external controller 110 shown in FIG. 1. The electrical cable 220 can provide power to components within the chlorinator device 210 as well as enable communication between the chlorinator device 210 and the external controller 260.

The housing 218 can contain internal components of the chlorinator device 210, such as flow sensors, salt sensors, and electrolyte plates as described in relation to FIG. 1 and as shown in more detail in other Figures and described in more detail below. These internal components are not visible in the external view of FIG. 2.

FIG. 2 also shows an example external controller 260 that can be used to control and communicate with the chlorinator device 210. The external controller 260 includes a housing 264 for protecting the various components within. It also includes input mechanisms 268, such as buttons or a touchscreen, to allow a user to interact with and control the system. In some examples, element 268 corresponds to a one or more lights than can be used to indicate the current state of the system.

The external controller 260 can be mounted separately from the chlorinator device 210, such as on a wall near the pool equipment. It communicates with and provides power to the chlorinator device 210 via the electrical connector 220. This separate controller configuration allows for convenient user access while keeping the chlorinator device itself installed inline with the pool plumbing. Furthermore, the external controller configuration separates the power supply and power transformers, which generate substantial heat, from the chlorinator device 210. This allows the chlorinator device 210 to have a simpler design than devices having onboard electronics. It also allows for modular replacement of different parts of the system 200.

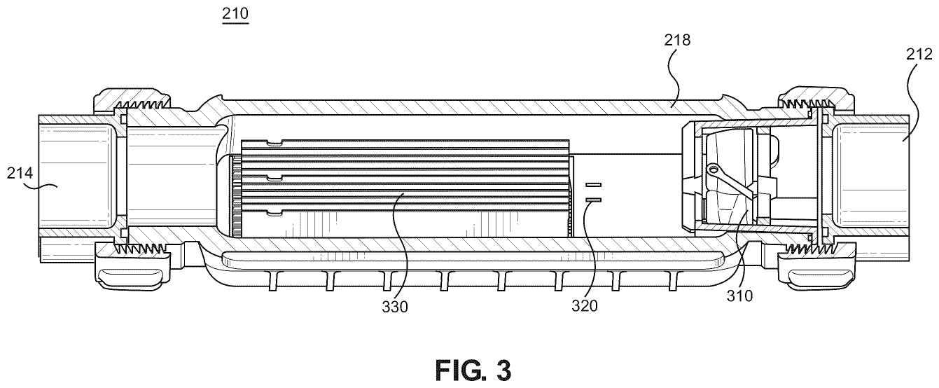

FIG. 3 illustrates a cross-sectional view of the example chlorinator device 210 of FIG. 2, which can also be used in the system shown in FIG. 1. The chlorinator device 210 shows a cross section through the housing 218. Within the housing 218, the chlorinator device 210 contains several internal components.

A flow sensor 310 is mounted within the housing 218 near the inlet end 212. The flow sensor 310 can alternatively be mounted near the outlet end 214, or elsewhere in the housing 218. In some examples, multiple flow sensors are utilized, such as by having one in each of the inlet and outlet ends 212, 214. The flow sensor 310 can be positioned to measure the flowrate of water as it enters and passes through the chlorinator device 210. In some examples, the flow sensor 310 can include a turbine with blades that rotate as water flows through it. The rotation speed of the turbine can be measured to determine the flowrate, such as by using a Hall-effect sensor to estimate rotations per minute. Other types of flow sensors may also be used, such as ultrasonic sensors or differential pressure sensors.

A salt sensor 320 can be mounted within the housing 218 downstream from the flow sensor 310. The salt sensor 320 can be configured to measure the salinity or conductivity of the water passing through the chlorinator device 210. Various types of salt sensors may be employed, such as inductive, conductive, or optical sensors. For instance, the salt sensor 320 may use a pair of electrodes to measure the electrical conductivity of the water, which correlates to salinity. Alternatively, the salt sensor 320 can use an optical refractometer to determine salinity based on the refractive index of the water. The salt sensor 320 can generate an electrical signal that is sent to an onboard controller (not shown) and then to the external controller 260 (shown in FIG. 2).

One or more electrolyte plates 330 can be mounted within the housing 218, in this example downstream from the salt sensor 320. The electrolyte plates 330 can be positioned to contact water flowing through the housing 218. In some examples, the electrolyte plates 330 can be implemented as a series of parallel metal plates, for example titanium with a ruthenium oxide coating. The plates 330 can be arranged in various configurations within the chlorinator housing to maximize water contact. For example, the plates may be oriented vertically, horizontally, or at an angle. The spacing between plates and total surface area may be optimized for chlorine generation efficiency.

When electrified, the electrolyte plates 330 can convert salt within the water into chlorine through electrolysis. The power level applied to the electrolyte plates 330 can be adjusted to control the rate of chlorine production based on various factors such as flowrate, salinity, and chlorine demand. Examples of scenarios where control over the rate of chlorine production are described in detail with respect to FIG. 1 above.

The internal components of the chlorinator device 210 can be connected to external control and power systems via an electrical cable (not shown in this figure), such as element 220 of FIG. 2, that extends from the housing 218. This allows for communication of sensor data and control of the electrolyte plates from an external controller.

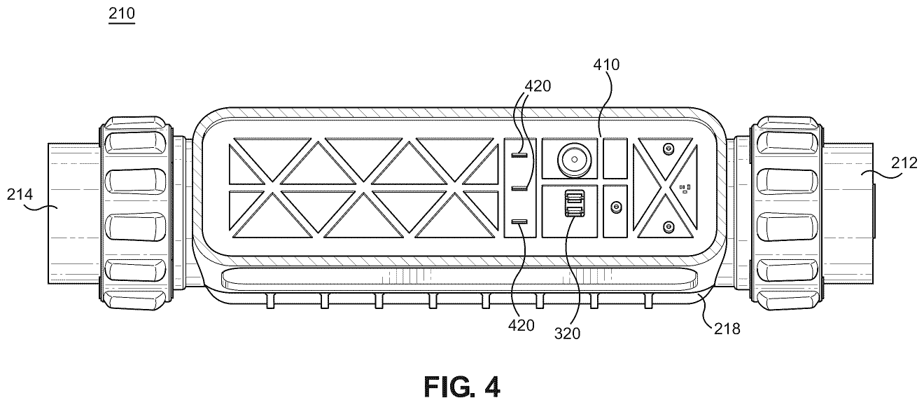

FIG. 4 illustrates a detailed cross-sectional view of the chlorinator device 210, which may be the same device shown in FIGS. 2 and 3. For example, the chlorinator device 210 shows the same housing 218 but at a different but parallel cross section, relative to FIG. 3.

Within the housing 218, a separation panel 410 is provided for mounting various components. The separation panel 410 can serve as a structural support and organizational element for the internal components of the chlorinator device 210. It can also delineate portions of the device 210 that have water flowing through, and portions that remain dry. The surface of the panel 410 shown in FIG. 4 is intended to remain dry, while the opposing surface is intended to contact water flowing through the device 210.

The salt sensor 320, previously described in relation to FIG. 3, is also visible in this cross-sectional view. The salt sensor 320 can be positioned to accurately measure the salinity or conductivity of the water flowing through the chlorinator device 210.

Connectors 420 that provide power to the electrolyte plates 330 may also be shown in this view. These connectors 420 can provide the necessary electrical power to the electrolyte plates 330 for the electrolysis process that converts salt in the water into chlorine. The connectors 420 can be designed to ensure configurable and efficient power transfer.

FIG. 4 does not depict a dedicated heat sink. Heat sinks, which are typically singular blocks of metal, are used in electronics applications where excessive heat is created. The heat sinks help dissipate the heat to the surrounding area. But regardless of that fact, electronics that produce excessive heat typically have shorter lifespans than similar electronics not subject to excessive heat. Heat sinks also add to the cost of manufacture. For these reasons, and to eliminate the need for a dedicated heat sink in this particular type of product and application, it is not considered desirable to have high heat-generating electronics onboard the chlorinator device 210 itself. When these types of electronics are mounted onboard a chlorinator device, they are difficult to access and service. This means that when they die, the whole chlorinator device must be replaced. The subject matter described herein aims to overcome these known issues by using an external controller, such as external controller 260, to house the high heat-generating electronics, such as the power supply and/or power transformer for providing power to the chlorinator device 210.

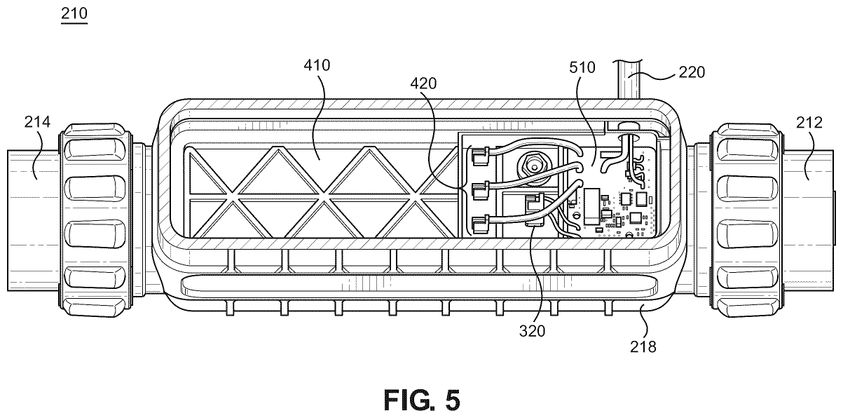

FIG. 5 illustrates a detailed cross-sectional view of the chlorinator device 210, which may be the same device shown in FIGS. 2-4. The cross section in this figure is moved up slightly compared to previous figures to show additional internal components.

Inside the housing 218, and mounted directly to the panel 410, a low-power onboard controller 510 is visible. This controller 510 can manage the internal operations of the chlorinator device 210, including processing sensor data and controlling the electrolyte plates 330. The low-power design of this onboard controller 510 allows it to operate without generating excessive heat, eliminating the need for a heat sink. Moreover, while the onboard controller can optionally route power from the external controller 260 to the plates 330, it does not function as a power supply or power transformer. In some embodiments, the lines connecting to connectors 420 are routed around the external controller 260 rather than through it. In either configuration, the specific arrangement of components described herein with respect to the chlorination system 200 of FIGS. 2-5 allow for the onboard controller 510 to be mounted directly to the panel 410 without the use of a dedicated heat sink.

This configuration, with the low-power onboard controller 510 and the absence of high-heat generating components, allows for a simpler and more reliable design compared to devices with onboard high-power electronics. The external controller configuration separates the power supply and/or power transformer, which can generate substantial heat, from the chlorinator device 210 itself. This arrangement allows for modular replacement of different parts of the system and improves overall system longevity and serviceability.

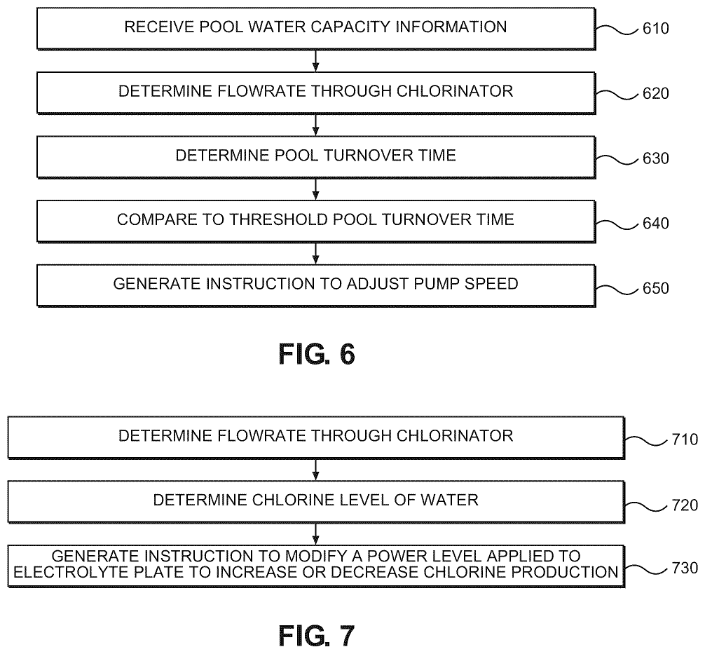

FIG. 6 illustrates a flowchart of an example method for managing pool water turnover using a chlorinator device. The method can be implemented by the chlorinator systems described in previous figures, such as the system shown in FIG. 1 or FIGS. 2-5. Because the methods of FIGS. 6-10 could apply to any systems, devices, or methods specified by the claims, rather than being specific to the examples described previously, no element numbering is used.

Stage 610 can include receiving pool water capacity information. This information can be obtained through various means. In some examples, a user can input the pool volume directly into a mobile application connected to the chlorinator system. In other examples, the pool capacity can be retrieved from a cloud-based database that stores information about the pool installation. In some examples, this stage is performed by the external controller.

Stage 620 can include determining the flowrate through the chlorinator. This determination can be made using the flowrate sensor described in earlier Figures, such as the flow sensor 122 shown in FIG. 1. The flowrate sensor can continuously monitor the water flow through the chlorinator device, providing real-time data. In some examples, the flowrate can be averaged over a specific time period to account for any short-term fluctuations. In some examples, this stage is performed by the external controller.

Stage 630 can include determining the pool turnover time. This calculation can be performed by dividing the total pool water capacity (obtained in stage 610) by the current flowrate (determined in stage 620). The result gives an estimate of how long it takes for the entire volume of pool water to pass through the filtration and chlorination system. In some examples, this calculation can be performed continuously or at regular intervals to provide up-to-date information on pool turnover. In some examples, this stage is performed by the external controller.

Stage 640 can include comparing the calculated pool turnover time to a threshold pool turnover time. The threshold time can be a predetermined value based on pool industry standards or user preferences. In some examples, the threshold time can be set to 24 hours, as many pool experts recommend turning over the entire pool volume at least once per day. The comparison can involve a simple numeric check to determine if the calculated turnover time exceeds the threshold. In some examples, this stage is performed by the external controller.

Stage 650 can include generating an instruction to adjust pump speed based on the comparison made in stage 640. If the calculated turnover time exceeds the threshold, the system can generate an instruction to increase the pump speed, thereby increasing the flowrate and reducing the turnover time. Conversely, if the turnover time is significantly below the threshold, the system can generate an instruction to decrease the pump speed, potentially saving energy while still maintaining adequate water circulation. In some examples, these instructions can be sent directly to a variable speed pump connected to the chlorinator system. In other examples, the instructions can be displayed to a user via a mobile application or control panel, allowing manual adjustment of the pump settings. In some examples, this stage is performed by the external controller.

The method illustrated in FIG. 6 can provide several advantages. By actively managing pool turnover time, the system can ensure proper water circulation and filtration, which can be crucial for maintaining water quality and chlorine distribution. Additionally, the ability to adjust pump speed based on actual turnover time can lead to more efficient energy use, potentially reducing operating costs for pool owners.

In some examples, the method can also incorporate additional factors into the decision-making process. For instance, the system can consider the time of day, expected pool usage patterns, or weather conditions when determining whether to adjust the pump speed. This can allow for more nuanced control of the pool circulation system, further optimizing both water quality and energy efficiency.

The method described in FIG. 6 can be implemented as part of a larger pool management system, working in conjunction with other features such as chlorine production control, water chemistry monitoring, and automated scheduling of pool equipment operation.

FIG. 7 provides a flowchart of an example method for using flowrate to adjust the power level applied to chlorine-generating metal plates. Stage 710 can include determining a flowrate through the chlorinator. This determination can be made using the flowrate sensor described in earlier Figures, such as the flow sensor 122 shown in FIG. 1. The flowrate sensor can continuously monitor the water flow through the chlorinator device, providing real-time data. In some examples, the flowrate can be averaged over a specific time period to account for any short-term fluctuations. In some examples, this stage is performed by the external controller. For example, the external controller can receive flowrate information to perform this stage.

Stage 720 can include determining a chlorine level of the water. This determination can be made using various methods. In some examples, a dedicated chlorine sensor may be included in the chlorinator device or elsewhere in the pool circulation system. Alternatively, the chlorine level can be estimated based on factors such as recent chlorine production rates, water temperature, and historical data on chlorine consumption patterns for the specific pool. In some examples, this stage is performed by the external controller. For example, the external controller can receive information from a chlorine sensor or ph/ORP sensor to perform the determination.

Stage 730 can include generating an instruction to modify a power level applied to the electrolyte plate to increase or decrease chlorine production. This instruction can be based on the flowrate determined in stage 710 and the chlorine level determined in stage 720. For example, if the chlorine level is below a desired threshold and the flowrate is sufficient, the system may generate an instruction to increase the power level applied to the electrolyte plate, thereby increasing chlorine production. Conversely, if the chlorine level is above the desired threshold or if the flowrate is low, the system may generate an instruction to decrease the power level, reducing chlorine production. In some examples, this stage is performed by the external controller. For example, a processor of the external controller can generate the instruction.

The method illustrated in FIG. 7 can provide several advantages. By dynamically adjusting chlorine production based on both flowrate and current chlorine levels, the system can maintain optimal water chemistry while potentially reducing energy consumption and extending the life of the electrolyte plates. This method can also help prevent over-chlorination, which can be harmful to swimmers and pool equipment.

In some examples, the method can incorporate additional factors into the decision-making process for adjusting chlorine production. These factors can include water temperature, pH/ORP levels, anticipated pool usage patterns, and weather forecasts. For instance, the system may increase chlorine production in anticipation of higher pool usage during hot weather or decrease production during periods of expected low usage.

The method described in FIG. 7 can be implemented as part of a larger pool management system, working in conjunction with other features such as automated pH control, pool pump speed adjustment, and user notification systems.

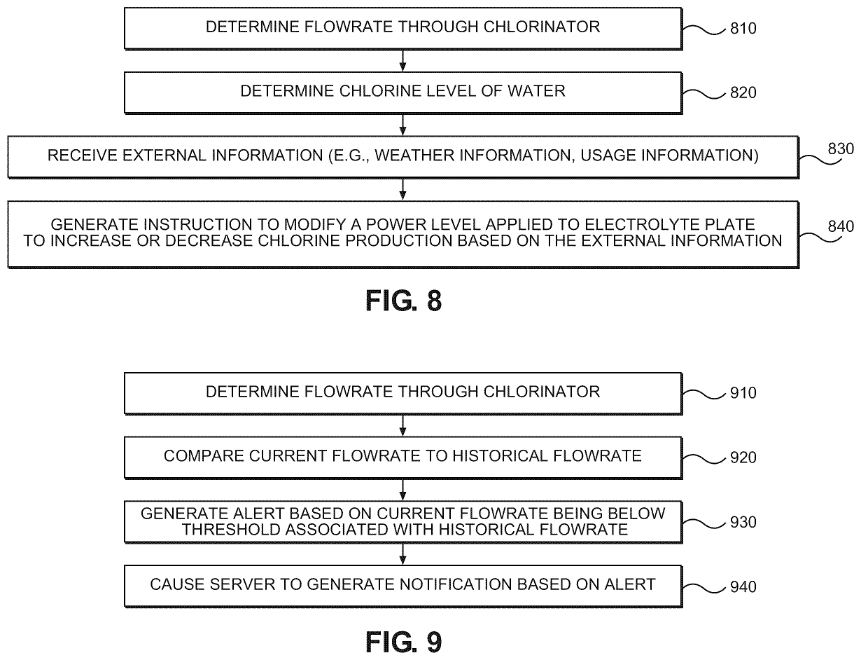

FIG. 8 includes a flowchart illustrating an example method for managing chlorine production in a pool system based on external information. Stage 810 of the example method can include determining a flowrate through the chlorinator. This determination can be made using the flowrate sensor described in earlier figures, such as the flow sensor 122 shown in FIG. 1. The flowrate sensor can continuously monitor the water flow through the chlorinator device, providing real-time data. In some examples, the flowrate can be averaged over a specific time period to account for any short-term fluctuations.

Stage 820 can include determining a chlorine level of the water. This determination can be made using various methods. In some examples, a dedicated chlorine sensor may be included in the chlorinator device or elsewhere in the pool circulation system. Alternatively, the chlorine level can be estimated based on factors such as recent chlorine production rates, water temperature, and historical data on chlorine consumption patterns for the specific pool.

Stage 830 can include receiving external information. This external information can encompass a wide range of data that may impact chlorine demand or pool usage. For example, weather information can be received from a weather API, as described in relation to FIG. 1. This can include current temperature, forecasted temperature, precipitation probability, and UV index. Usage information can be received from a user's calendar or from historical usage patterns stored in the system. For instance, the system may receive information about an upcoming pool party or regular swim team practice sessions.

Stage 840 can include generating an instruction to modify a power level applied to the electrolyte plate (which can be multiple plates) to increase or decrease chlorine production based on the external information. This stage integrates the information gathered in the previous stages to make an informed decision about chlorine production. For example, if the weather forecast indicates an upcoming heatwave and the user's calendar shows increased pool usage, the system may generate an instruction to increase the power level to the electrolyte plate, thereby increasing chlorine production in anticipation of higher demand. Conversely, if cool, rainy weather is forecasted and no pool usage is scheduled, the system may generate an instruction to decrease the power level, reducing chlorine production to conserve energy and resources.

In some examples, the method illustrated in FIG. 8 can provide several advantages. By incorporating external information into the decision-making process, the system can proactively adjust chlorine production to match anticipated demand. This can help maintain optimal water chemistry while potentially reducing energy consumption and extending the life of the electrolyte plates. The method can also enhance user experience by ensuring the pool is always ready for use, regardless of weather conditions or usage patterns.

The method described in FIG. 8 can be implemented as part of a larger pool management system, working in conjunction with other features such as automated pH control, pool pump speed adjustment, and user notification systems. It can be executed continuously or at regular intervals to ensure the pool system is always operating at optimal efficiency based on the most current information available.

FIG. 9 provides a flowchart of an example method for detecting potential issues with a pool filtration system using flowrate data from a chlorinator device. Stage 910 of the example method includes determining a flowrate through the chlorinator. This determination can be made using the flowrate sensor described in earlier figures, such as the flow sensor 122 shown in FIG. 1. The flowrate sensor can continuously monitor the water flow through the chlorinator device, providing real-time data. In some examples, the flowrate can be averaged over a specific time period to account for any short-term fluctuations.

Stage 920 can include comparing the current flowrate to historical flowrate data. This comparison can help identify potential issues with the pool's filtration system. Historical flowrate data can be stored in the system's memory or in a cloud-based database. The historical data can include average flowrates for different times of day, different seasons, or under various operating conditions. In some examples, the system can use machine learning algorithms to establish baseline flowrate patterns for the specific pool system.

Stage 930 of the example method includes generating an alert based on the current flowrate being below a threshold associated with the historical flowrate. This threshold can be a predetermined percentage of the historical average flowrate, or it can be dynamically adjusted based on various factors such as time of day, season, or recent pool usage patterns. For example, if the current flowrate is 20% lower than the historical average for similar conditions, an alert may be generated. In some examples, the system can use multiple thresholds to indicate different levels of concern, such as a “warning”level and a more serious “alert”level.

Stage 940 can include causing a server to generate a notification based on the alert. This notification can take various forms depending on the severity of the issue and user preferences. In some examples, the notification can be a push notification sent to a user's mobile device through a dedicated pool management application. In other examples, the notification can be an email or text message sent to the pool owner or maintenance personnel. The notification can include details about the detected issue, such as the current flowrate, the historical average, and the percentage decrease. It can also provide recommendations for troubleshooting or maintenance actions.

In some examples, the method illustrated in FIG. 9 can provide several advantages. By continuously monitoring flowrate and comparing it to historical data, the system can detect potential issues with the pool's filtration system before they become serious problems. This can help prevent equipment damage, maintain water quality, and potentially reduce energy costs by identifying inefficiencies early. The automated alert and notification system can ensure that pool owners or maintenance personnel are promptly informed of any issues, allowing for timely intervention.

The method described in FIG. 9 can be implemented as part of a larger pool management system, working in conjunction with other features such as chlorine production control, water chemistry monitoring, and automated scheduling of pool equipment operation. By integrating flowrate monitoring with these other functions, the system can provide a comprehensive approach to pool maintenance and optimization.

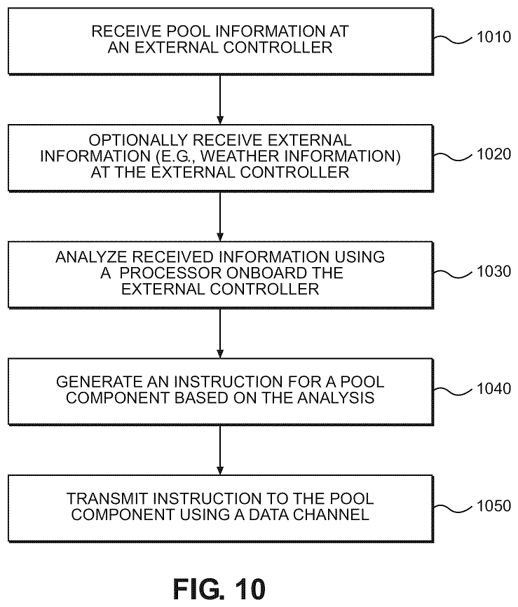

FIG. 10 illustrates a flowchart of an example method for generating instructions for pool components, which can be performed by the external controller described above. Stage 1010 can include receiving pool information at an external controller. Pool information can include any information relevant to the pool for which the external controller operates and is not limited to information generated by the chlorinator device. For example, pool information can include pool capacity, current and/or historical flowrate through the chlorinator device, ph/ORP sensor information, chlorine level information, water-level sensor information, pool pump speed and/or operational status, acid pump speed and/or operational status, power level applied to chlorine-generating plates of chlorinator, and any other information generated or provided by pool-dedicated components.

Pool information can also include usage information for pool components. This can include, for example, aggregate runtime for components such as pool pumps, acid pumps, and the chlorinator device. Aggregate runtime values can be useful for tracking warranty availability for devices. For example, tracking the runtime of a chlorinator can guard against misuse, such as when a pool builder installs a chlorinator that is too small for the pool's capacity, resulting in the chlorinator running more hours than what would otherwise be expected or recommended by the manufacturer. In such case, the chlorinator may exceed its warranty runtime much faster than expected, and tracking such information would allow the manufacturer to avoid unknowing applying a warranty to a product that has exceeding warranty limits.

In some examples, the pool information received at stage 1010 is generated by the external controller itself. Continuing the previous example of a chlorinator's runtime history, the external controller can track the chlorinator's runtime based on tracking the time during which power is applied from the external controller to the metal blades of the chlorinator. In this way, the chlorinator device itself need not track usage information, leaving that to the external controller. In some examples, the pool information receive at stage 1010 is received from a mobile application that allows a user to provide such information. This can include, for example, a user's preference for how many hours to run the pool pump each day, the time of the day to run the pool pump or other components, how many times to turn over the pool in a period of time, and similar user information.

At stage 1020, the external controller can optionally receive external information. This external information can encompass a wide range of data that may impact chlorine demand or pool usage. For example, weather information can be received from a weather API, as described in relation to FIG. 1. This can include current temperature, forecasted temperature, precipitation probability, and UV index. Usage information can be received from a user's calendar or from historical usage patterns stored in the system. For instance, the system may receive information about an upcoming pool party or regular swim team practice sessions.

At stage 1030, the external controller can analyze the information received at stages 1010 and 1020 using a processor onboard the external controller. Analyzing can include various different steps depending on the example. In one example, analyzing the information includes accessing stored information, such as look-up tables, and comparing the received information to the values in the look-up table. This process can indicate one or more potential instructions to be generated based on the received information. For example, the received information can be data from a pH/ORP sensor, and the look-up table can indicate that the current sensor information indicates a need to turn off an acid pump for a specific period of time.

In some examples, multiple analysis stages can occur at stage 1030. For example, the external controller can consider multiple sources of information and intelligently correlate or discount the sources of information against one another in order to land on an appropriate instruction for the pool system. Continuing the example above where the pH/ORP look-up table indicates the need to turn off the acid pump, the external controller can also consider external weather information, indicating that heavy rain is expected for the next several days. In that example, the external controller may calculate that the rain will adjust the pH/ORP sensor values appropriately without any change to the acid pump's scheduled operation. In that example, the external controller can determine that no instruction to turn off the acid pump is necessary.

At stage 1040, the external controller can generate an instruction for a pool component based on the analysis performed at stage 1030. The instruction can be specific to the chlorinator device, as explained in earlier example methods, but in some examples can relate to other devices entirely. For example, the instruction generated at stage 1040 can instruct an acid pump to turn on or off, instruct a pool pump to turn on or off, instruct a fill valve to open to add water to the pool, instruct a drain valve to open to remove water from the pool, instruct a heat pump to turn on or off, or provide any other instruction relevant to any other pool component.

Stage 1050 can include transmitting the instruction generated at step 1040 to the appropriate device. This instruction can be transmitted using any data channel, such as a wireless network using known wireless communication protocols, or a dedicated low-voltage data cable using known communication protocols such as RS485 or similar protocols. For example, the transmission at stage 1050 can include transmitting an instruction over a wired data channel to a pool controller, instructing the pool controller to turn off the pool pump. In another example, the instruction is transmitted over the data channel directly to the pool pump, instructing it to turn off. In yet another example, the instruction is transmitted wirelessly to a smart valve that opens a fill valve.

Although described as an “instruction” in the method of FIG. 10, the instruction can be a response to a request in some scenarios. For example, the external controller can be connected to a pool controller, either wirelessly or via a wired connected. The pool controller can request information from the external controller, such as a current status of the chlorinator device, weather information for the next day, or any other information potentially available to the external controller. The external controller can receive the request from the pool controller, process it, and provide a response back to the pool controller. This process can occur in the context of the method of FIG. 10, where the “instruction” is actually a response back to the pool controller based on a request received.

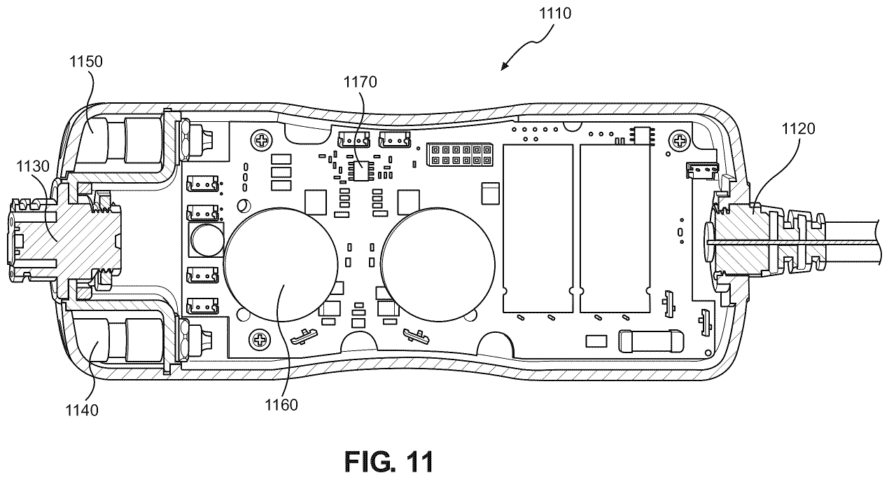

FIG. 11 provides a cross-sectional view of an example external controller 1110 according to one or more embodiments herein. The external controller 1110 can be used to connect a chlorinator device, such as the example chlorinator devices described with respect to FIGS. 1-5, to a power source. The external controller 1110 can also provide various functionalities described herein.

The external controller 1110 includes a power-supply connector 1120 that provides electrical communication between the external controller 1110 and a power source. In some examples, the power source is a pool controller that provides power to various pool components. The power-supply connector 1120 can also be configured to transmit data in addition to power, allowing the external controller 1110 to communicate with a pool controller type of power source. This can allow the external controller 1110 to receive commands or information from the pool controller, such as weather information or information regarding other pool components. As another example, the external controller 1110 can receive information indicating a current pump speed of a pool pump, information indicating the current alchemy of the water in the pool, and information indicating a water level of the pool.

In some examples, these and other types of information can be received at the external controller 1110 through a wireless communication module within the controller 1110. The wireless communication module can be a WIFI-capable chipset, for example. It can allow the external controller 1110 to connect to a wireless network that, in turn, allows the controller 1110 to send and receive information to and from remote sources such as a server or cloud system. This is explained in more detail with respect to the cloud platform 140 of FIG. 1, which allows for a connection to external APIs 150 and a mobile device 130 among other things.

The external controller 1110 can also include a chlorinator connector 1130 for providing electrical communication between the external controller 1110 and the chlorinator device. The chlorinator connector 1130 can be a hardwire connection that provides power conditioned for the chlorinator. The power can be conditioned using a power converter 1160 or similar type component or set of components. In some examples, the power received at the external controller 1110 is preconditioned by the power supply, such that the external controller 1110 receives a voltage and amperage that is suitable for all components in the system. In other examples, the power received at the external controller 1110 is further modified or conditioned by the controller 1110 before being provided to the chlorinator. This can include amplifying or reducing the received power to suit the needs of the components to be powered.

The chlorinator connector 1130 can also be used to send information from the chlorinator device to the external controller 1110. For example, the chlorinator device can gather flowrate sensor information based on fluid flowing through the device. In some examples, the chlorinator can send the raw data gathered by the sensor to the external controller 1110, such that the controller 1110 is left to analyze the data. In other examples, the chlorinator processes the data before sending it to the controller 1110.

The connection between the chlorinator device and the external controller 1110, via chlorinator connector 1130, can be encrypted such that only authorized devices can communicate with one another. This can include, for example, requiring an encrypted handshake procedure before the external controller 1110 is permitted to send or receive any signal or power between it and the chlorinator device. This can prevent unauthorized devices from being utilized with the components described herein, which could potentially cause damage or other problems with the system.

The data received at the external controller 1110 can be processed via a hardware-based processor 1170. The processor 1170 can be a single chip or a set of multiple chips working together. It can also utilize one or more memory components mounted to the circuit board, allowing the processor 1170 to store and retrieve information from a memory storage. The processor 1170 can handle any encryption authentication procedures, such as the encrypted handshake procedure described above. The processor 1170 can also process raw data received from any external sensors, such as a flowrate sensor on the chlorinator device. The processor 1170 can also provide instructions to external devices, such as the chlorinator device or a pool controller connected via the power source connector 1120. The processor 1170 is the component responsible for receiving instructions, generating instructions, and carrying out instructions where applicable. For example, the processor 1170 can request information from a cloud platform, analyze any information provided in response, and act on that information to generate and send instructions for one or more pool components.

The processor 1170 can also receive information from other sources, such as through additional component connectors 1140, 1150. These component connectors 1140, 1150 can be used to connect additional components via a hardwire connection. For example, the component connectors 1140, 1150 can connect to pool components such as a pH/ORP sensors, water-level sensors, temperature sensors, flow meters, or any other type of pool components that are capable of digital communications. In some examples, the component connectors 1140, 1150 utilize low power data communication protocols such as RS485 or similar protocols. The data received via the component connectors 1140, 1150 can be processed by the processor 1170, which can also provide instructions to the components using the same connectors 1140, 1150.

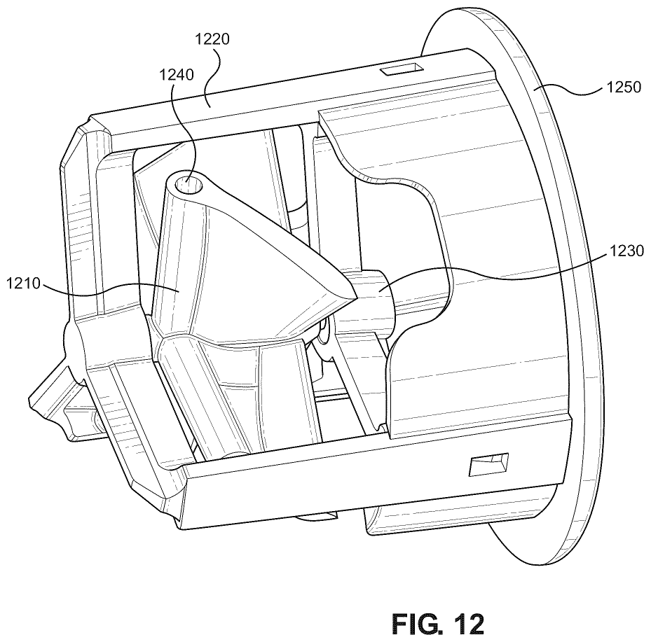

FIG. 12 provides a perspective view of an example flowrate sensor according to one or more embodiments herein. The flowrate sensor of FIG. 12 is a turbine-style flow sensor that includes a turbine 1210 with multiple blades. The blades are oriented such that fluid flowing through the flowrate sensor causes the turbine 1210 to rotate. In one example, at least one blade of the turbine 1210 includes an insert 1240. This insert 1240 can be a magnet or any other item capable of being sensed by another sensor device in proximity of the flowrate sensor. In the example of a Hall effect sensor, for example, the insert 1240 can be a magnet while the Hall effect sensor is placed elsewhere in the chlorinator device, such as on a circuit board that does not contact the fluid flowing through the flowrate sensor.

Referring back to FIG. 3, the flowrate sensor can be arranged such that the turbine 1210 rotates about an axis aligned with the general fluid flow through the chlorinator device. For example, the chlorinator device can have a flow axis extending between the centers of the inlet and outlet portions of the chlorinator device. The flowrate sensor can be oriented in the device such that the turbine 1210 rotates about the same flow axis. By aligning the flowrate sensor's moving parts with the flow direction, blockages and malfunctions due to debris, air bubbles, or other flow disruptions can be minimized. This design provides a benefit over other types of flowrate sensors that include rotating parts that do not rotate about an axis aligned with the fluid flow through the sensor, such as a paddle wheel,

The turbine 1210 of the flowrate sensor can be held in place using a flowrate sensor cage 1220 and a flowrate sensor brace 1230. Because this design provides the turbine in a position to rotate about an axis aligned with the fluid flow through the sensor, the outer walls of the chlorinator device is not used for attaching the flowrate sensor. Instead, the turbine 120 of the flowrate sensor requires mounting points that are positioned along the flow axis. The cage 1220 can be shaped to provide one such mounting point, as shown. The brace 1230 can fit within a portion of the cage 1220 can provide the opposing mounting point for the turbine 1210.

In some examples, the cage 1220 of the flowrate sensor includes a lip 1250 that protrudes radially from the central flow axis. The lip 1250 can be used for mounting and retaining the flowrate sensor in the chlorinator device. In one example, the lip 1250 works in conjunction with one or more seals, such as O-rings, to seal the connection between the flowrate sensor and the chlorinator device. This can allow assembly by inserting the flowrate sensor into an opening of the chlorinator device that receives fluid flow, with the lip 1250 sized to cover an edge of the opening rather than fitting within the opening. This is shown in cross section in FIG. 3, for example.

The lip 1250 can be compressed against the opening of the chlorinator device by using a fitting that attaches an inlet pipe to the chlorinator device. For example, and as also shown in FIG. 3, the flowrate sensor can abut an inlet of the chlorinator device on one side of the lip 1250 of the flowrate sensor and abut an inlet pipe on the other side of the lip 1250. These components can be compressed together using the fitting, which is shown in FIG. 3 as being threaded to the chlorinator device in a manner which forces the inlet pipe against the lip 1250, and in turn against the opening of the chlorinator device. This compressive force can appropriately compress one or more O-rings to prevent water from leaking through the connection of these components.

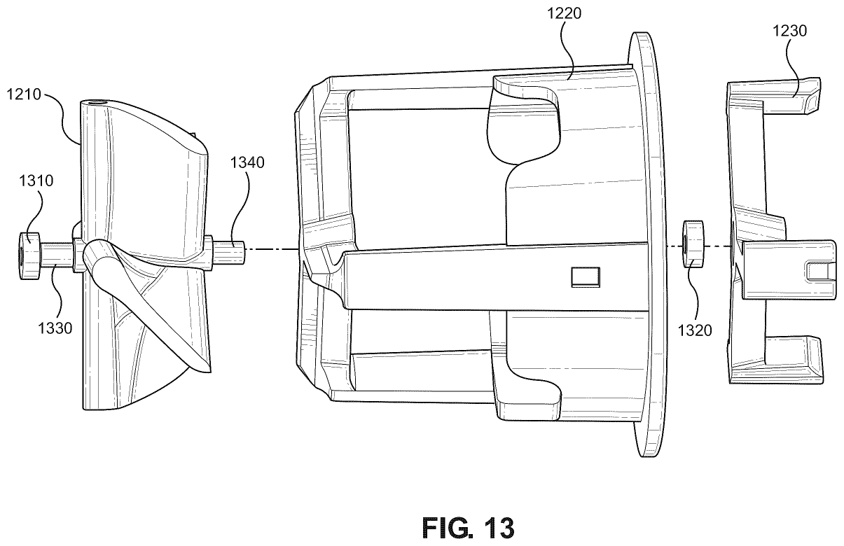

FIG. 13 provides an exploded view of the flowrate sensor of FIG. 12. In addition to the components discussed with respect to FIG. 12, this drawing also shows bearings 1310, 1320 and matching shafts 1330, 1340 on the turbine 1210. In some examples, the shafts 1330, 1340 can be a single member, such as a titanium pin. However, the shafts 1330, 1340 can alternatively be separate members. They can also be made from any suitable material, although a robust material is preferred.

The turbine 1210 can experience high angular velocity (i.e., rotational speeds) for extended periods of time over its life. These rotational speeds can cause substantial wear on certain components, such as components that experience friction based on the rotation. To solve this problem, bearings 1310, 1320 are provided for supporting the shafts 1330, 1340 and lowering the friction experienced due to rotation of the turbine 1210. In some examples, these bearings 1310, 1320 are ceramic bearings that provide a low friction interface while preventing unwanted wear. In an example, the various components shown in FIG. 13 are held together based on certain portions of the flowrate sensor brace 1230 snapping into corresponding holes of the flowrate sensor cage 1220. An example of such corresponding holes include the rectangular hold in the cage 1220 depicted in FIG. 13.

The flowrate sensor of FIGS. 12 and 13 has a modular design, making it possible to easily remove or replace. This can be useful for performing maintenance on the chlorinator device, including debris removal, parts inspection, or parts replacement. As an example, a user can remove the fitting shown in FIG. 3 that retains the flowrate sensor and inlet pipe, thereby releasing the pipe and flowrate sensor. The user can then remove the flowrate sensor and perform any necessary maintenance. The user can then reinstall the same or a new flowrate sensor in the original location, and can also inspect and replace the O-ring(s) if necessary. The user can reinstall the inlet pipe and fitting to secure the flowrate sensor back in the chlorinator device.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order.

The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A chlorinator device for generating chlorine in a body of water, comprising:
a housing including an inlet and outlet;
at least one electrolyte plate mounted within the housing and positioned to contact water flowing through the housing to covert salt within the water into chlorine;
a flowrate sensor assembly comprising:
a cage including at least one bearing; and
at least one turbine blade inside the cage and coupled to the at least one bearing,
wherein the flowrate sensor assembly does not include any electrical connections.

2. The chlorinator device of claim 1, wherein the cage of the flowrate sensor assembly includes a lip configured such that, when the flowrate sensor assembly is inserted into the inlet, the lip contacts an outer surface of the inlet.

3. The chlorinator device of claim 2, wherein the cage of the flowrate sensor assembly is secured to the housing using a threaded connector that couples an inlet pipe to the inlet.

4. The chlorinator device of claim 2, wherein the lip of the flowrate sensor assembly is the only portion of the flowrate sensor assembly that contacts the housing.

5. The chlorinator device of claim 2, wherein the lip further includes an O-ring, and wherein the threaded connector applies a force that compresses the O-ring by securing the lip to the inlet.

6. The chlorinator device of claim 1, wherein the at least one turbine blade includes a magnet secured to the blade.

7. The chlorinator device of claim 1, wherein the housing includes a sensor for detecting movement of a magnet secured to the at least one blade.

8. The chlorinator device of claim 1, wherein the at least one bearing includes two bearings in axial alignment with each other.

9. The chlorinator device of claim 7, wherein the axial alignment of the two bearings is substantially aligned with a direction of fluid flow through the housing.

10. The chlorinator device of claim 1, wherein the at least one turbine blade comprises four turbine blades.

11. A modular flow sensor assembly, comprising:
a cage including two bearings;
a shaft coupled to the two bearings and oriented in a direction substantially parallel to a direction of flow through the sensor assembly; and
a plurality of turbine blades coupled to the shaft,
wherein the modular flow sensor assembly does not include any electrical connections.

12. The modular flow sensor assembly of claim 11, wherein the cage of the flowrate sensor assembly includes a lip having an outer diameter that is larger than the outer diameter of the remaining portions of the cage.

13. The modular flow sensor assembly of claim 11, wherein the lip of the cage includes a surface configured to receive an O-ring.

14. The modular flow sensor assembly of claim 11, wherein at least one of the plurality of turbine blades includes a magnet.

15. The modular flow sensor assembly of claim 11, wherein the magnet is disposed within a body of the at least one of the plurality of turbine blades.

16. The modular flow sensor assembly of claim 11, wherein the magnet is secured to an outer surface of the at least one of the plurality of turbine blades.

17. The modular flow sensor assembly of claim 11, further comprising a brace disposed within the cage and housing at least one of the bearings.

18. A method for installing a flowrate sensor assembly in a chlorinator device having an inlet and an outlet, comprising:
providing the flowrate sensor assembly comprising:
a cage including at least one bearing;
at least one turbine blade inside the cage and coupled to the at least one bearing; and
a lip that protrudes from the cage,
inserting the flowrate sensor assembly into the inlet of the chlorinator device such that the lip contacts an outer surface of the inlet; and
securing the flowrate sensor assembly to the inlet by installing a threaded connector that presses the lip against the outer surface of the inlet.

19. The method of claim 18, further comprising placing an O-ring on the lip, such that securing the flowrate sensor assembly to the inlet includes compressing the O-ring.

20. The method of claim 18, wherein securing the flowrate sensor assembly to the inlet by installing a threaded connector further comprises abutting an inlet pipe to the lip such that the threaded connector secures the inlet pipe to the chlorinator device.
